(19) United States
(12) Patent Application Publication
(10) Pub. No.: US 2021/0070543 A1
(43) Pub. Date: Mar. 11, 2021

(54) TRASH HANDLER DEVICE AND METHOD

(71) Applicant: Lennie Breeze, Hillsborough, NC (US)

(72) Inventor: Lennie Breeze, Hillsborough, NC (US)

(21) Appl. No.: 16/890,365

(22) Filed: Jun. 2, 2020

Related U.S. Application Data
(60) Provisional application No. 62/897,541, filed on Sep. 9, 2019.

(51) Int. Cl. B65F 1/14; B65B 67/12; A45F 5/02

(52) U.S. Cl. CPC B65F 1/1415; A45F 5/021; B65B 67/1233

(57) ABSTRACT

A trash handler device is disclosed herein. The trash handler device functions to hold a flexible bag in an open position, The device includes a support hoop configured to support the flexible bag in the open position, an elongated arm joined with such support hoop, a handgrip configured to assist manual gripping of such elongated arm, an arm cuff configured to supportively engage a user's arm during use, and a bag attacher configured to removably attach the flexible bag to the support hoop.

### CROSS-REFERENCE TO RELATED APPLICATIONS

The present application is related to and claims priority to U.S. Provisional Patent Application No. 62/897,541 filed 9 Sep. 2019, which is incorporated by reference in its entirety.

### BACKGROUND OF THE INVENTION

The following includes information that may be useful in understanding the present disclosure. It is not an admission that any of the information provided herein is prior art nor material to the presently described or claimed devices, nor that any publication or document that is specifically or implicitly referenced is prior art.

### TECHNICAL FIELD

The present device generally relates to the field of article carriers of existing art and, more specifically, relates to bag-holding carriers supported from a limb of the user.

### RELATED ART

Many activities require a user to collect and temporally store small quantities of an item for later transportation to a larger storage receptacle or processing site. For example, an individual may collect trash into a flexible bag for transport to a waste receptacle. Without a way to properly keep the flexible bag open, time is wasted trying to put trash in a bag that does not remain open, especially in windy conditions. Attempting to carry a loose bag can be frustrating, and trying to hold and control the configuration of the bag opening is difficult. Also, holding onto a garbage bag does not leave both hands free to pick up trash or debris. A suitable solution would benefit many.

Applicant's prior U.S. patent application Ser. No. 13/239,556 describes a utility hopper for holding a trash bag open while allowing a user to support and carry it with ease. The prior-disclosed apparatus comprises a rigid support frame and a plurality of clips that attach to and hold open a garbage bag. The support frame has a support arm that extends from it, which the user secured to his or her forearm, along with a gripping handle that the user held in his or her hand. The device keeps the bag open for easy trash placement thereinto. Alternatively, a netted mesh bag may be used in place of the garbage bag to avoid the waste associated with their disposal. The mesh bags may also serve as temporary storage space for items that were later transferred to a larger storage receptacle. The prior apparatus could also be attached to a user's belt with a clip for transport when not in use. Although Applicant's prior apparatus reduced the amount of stress placed on a user's wrist when using the utility hopper apparatus for collecting items, the user was required to maintain their arm in a raised or semi-raised position during use.

The device of the present disclosure substantially diverges in design from the prior apparatus. The device of the present disclosure comprises a configuration providing improved ergonomics allowing the user's arm to remain in a more relaxed downward position during use.

### SUMMARY OF THE INVENTION

Given the foregoing disadvantages inherent in the known bag-holding carriers supported from a limb of the user art, the present disclosure provides a novel trash handler device. The general purpose of the present disclosure is to provide a trash handler device for use in collecting debris or for the temporary storage of harvested items.

This disclosure provides a trash handler device for holding a flexible bag in an open position comprising a support hoop configured to support the flexible bag in the open position, such support hoop having a rigid peripheral member generally disposed within a geometric plane and defining an opening through which articles may pass; an elongated arm joined with such support hoop, such elongated arm having a proximal end extending outwardly from such rigid peripheral member, a distal end opposite the proximal end, and a longitudinal axis extending between such proximal end and such distal end, such longitudinal axis fixed at an angle oblique to such geometric plane; a handgrip configured to assist manual gripping of such elongated arm, such handgrip joined with such elongated arm at a position between such proximal end and such distal end; an arm cuff configured to supportively engage a user's arm during use, such arm cuff joined with such elongated arm at a position next such distal end; and a bag attacher configured to removably attach the flexible bag to the rigid peripheral member of the support hoop.

This disclosure also a method of using a trash handler device to hold a flexible bag in an open position to facilitate the depositing of debris a rigid peripheral member generally disposed within a geometric plane and defining an opening through which articles may pass, an elongated arm joined with such support hoop, such elongated arm having a proximal end extending outwardly from such rigid peripheral member, a distal end opposite the proximal end, and a longitudinal axis extending between such proximal end and such distal end, such longitudinal axis fixed at an angle oblique to such geometric plane, a handgrip therein, the method comprising the steps of: providing a trash handler device comprising a support hoop configured to support the flexible bag in the open position, such support hoop having configured to assist manual gripping of such elongated arm, such handgrip joined with such elongated arm at a position between such proximal end and such distal end, an arm cuff configured to supportively engage a user's arm during use, such arm cuff joined with such elongated arm at a position next such distal end, and a set of spring-actuated clips each one configured to removably attach the flexible bag to the rigid peripheral member of the support hoop; removably attaching the flexible bag to the support hoop in the open position using the set of spring-actuated clips; manually gripping the handgrip to assist user positioning of the opening; and arranging the trash handler device such that the U-shaped member partially encircles a user's arm; whereby the flexible bag is held by the user in an open position to facilitate the depositing of the articles therein.

This document describes certain aspects, advantages, and novel features of the device. A particular version of the device does not necessarily achieve all such advantages. Thus, the device may be designed or practiced in a manner that achieves or optimizes one advantage or group of advantages without necessarily achieving other advantages. The claims point out the novel device features.

### BRIEF DESCRIPTION OF THE DRAWINGS

The figures which accompany the written portion of this specification illustrate embodiments and methods of use for the present disclosure, a trash handler device, constructed and operative according to the teachings of the present disclosure.

FIG. 1 is a side view of the trash handler device during an ‘in-use’ condition, according to an embodiment of the disclosure.

FIG. 2 is a perspective view of the trash handler device of FIG. 1, according to an embodiment of the present disclosure.

FIG. 3 is a side view of the trash handler device of FIG. 1, according to an embodiment of the present disclosure.

FIG. 4 is a top view of the trash handler device of FIG. 1, according to an embodiment of the present disclosure

FIG. 5 is a perspective view of the trash handler device of FIG. 1, according to an embodiment of the present disclosure.

FIG. 6 is a sectional view through section 6-6 of FIG. 2, illustrating features of an elongated arm of the trash handler device of FIG. 1, according to an embodiment of the present disclosure.

FIG. 7 is a flow diagram illustrating a method of use for the trash handler device, according to an embodiment of the present disclosure.

### DETAILED DESCRIPTION

As discussed above, embodiments of the present disclosure relate to bag-holding carriers supported from a limb of the user and, more particularly, to a trash handler device as used to improve the manual collection of trash and other articles.

Generally, the present device provides a convenient and efficient device for keeping a garbage bag open, even in windy conditions, to make it easier to deposit trash and other debris. Effectively, the device offers an easy way to keep garbage bags open during use and provides a handy, convenient, and quick system of positioning the bag with the least amount of stress on the user's wrist, elbow, and arm. The bags are accessible, maneuverable, open, stable, and not cumbersome to use, even in windy situations. The device is useful for many individuals because everyone comes in contact with trash daily. Users may include homeowners, businesses, high schools, middle schools, elementary schools, universities, colleges, hospitals, football stadiums, baseball stadiums, soccer stadiums, churches, stores, shopping centers, towns, cities, municipalities, landscapers, lawn care providers, farmers, gardeners, contractors, civic groups, boy scouts, girl scouts, jails, banks, restaurants, gas stations, truck stops, police department, courthouses, apartment complexes, hotels, and the like. Anyone that needs to pick up trash could use this device. The ease of use is an important feature of the device. The bag stays open, even in the wind, and the rigid frame makes it very user friendly.

This device is light and smaller people may be able to carry. It is comfortable to hold, and the unit is constructed in a manner that makes positioning manageable with or without a bag. Even when the bag gets full, one can leap-frog it along until the trash bag is replaced. This device is useful in gathering trash in a trash bag that can be thrown in a large garbage receptacle. It eliminates the need first to place the trash in five-gallon buckets, then to transfer the trash to another container. Bags can directly attach to the device.

The device comprises a hoop having a diameter of about 16 inches having several evenly spaced spring clips to hold the bags in place. A support arm is attached to the hoop at one point. The hoop is oriented either perpendicular to or at an angle relative to the hoop. The support arm is about 14 inches long and reaches to about the user's inner elbow. At the upper end of the support arm is a cuff that cradles the user's arm when carrying the device. The cuff is configured like the cuffs on some crutches. A gripping handle is located on the support arm about 4 inches from the hoop. The gripping handle extends about 5 inches outwardly from the support arm and points toward the center of the hoop. On the back of the support arm, near the arm cuff, is a belt clip for hands-free carry. On the back of the support arm, near the gripping handle, is another belt clip used to assist in attaching bags to the device.

The device may be carried on the user's belt by the upper belt clip for hands-free carry. During use, the user holds the device by gripping the handle and attaches the device to the user's belt using the belt clip located on the lower part of the unit near the gripping handle. After securely attaching the unit to the user's belt using both hands, the user holds the unit with one hand and retrieves a trash bag to attach to the hoop. Using their free hand, the user places the bag on the hoop from the inside. With the other hand, the user manipulates a spring clip to secure the bag to the hoop. The user continues until all the clips are used to attach the bag to the perimeter of the hoop. The user next removes the unit from the belt and holds it by the gripping handle with the cuff engaging the user's forearm. With a bag in place, the user is ready to collect trash. Trash is placed inside the bag until full. When full, the user unclips and removes the bag from the hoop before placing another bag on the device.

This device is simple to use, lightweight, and handy. The unique configuration of the support arm, grip, and hoop allows the unit to be used with the user's arm resting in a natural downward position, thus reducing fatigue. The device may be used indoors or outdoors. Alternately, the device may be used to gathering other articles, such as fruits or vegetables. Moreover, the device may serve as an improved structure for supporting the weight of other collected items, or as an extension of the user's arm. The device may be used to scoop up trash, collect harvest items or capture fish, crabs, or shrimp.

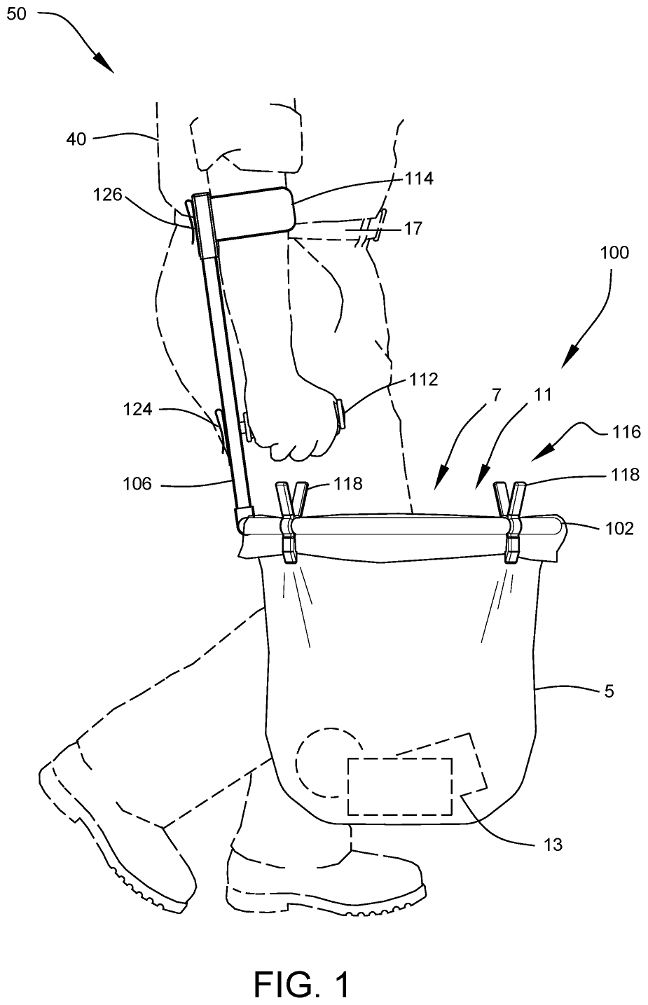

Referring now more specifically to the drawings by numerals of reference, there is shown in FIGS. 1-6, various views of a trash handler device 100.

FIG. 1 shows the trash handler device 100 during an ‘in-use’ condition 50, according to an embodiment of the present disclosure. Here, the trash handler device 100 may be beneficial for use by a user to support a flexible bag 5 in an open position 7 to facilitate the gathering of articles 13. As illustrated, the trash handler device 100 may include a support hoop 102 configured to support the flexible bag 5 in the open position 7, an elongated arm 106 joined with the support hoop 102, a handgrip 112 configured to assist manual gripping of such elongated arm 106, an arm cuff 114 configured to engage and support a user's arm during use, and a bag attacher 116 configured to removably attach the flexible bag 5 to the support hoop 102. The trash handler device 100 of the present disclosure provides improved ergonomics by positioning the user's arm in a more relaxed downward position during use, as shown in FIG. 1.

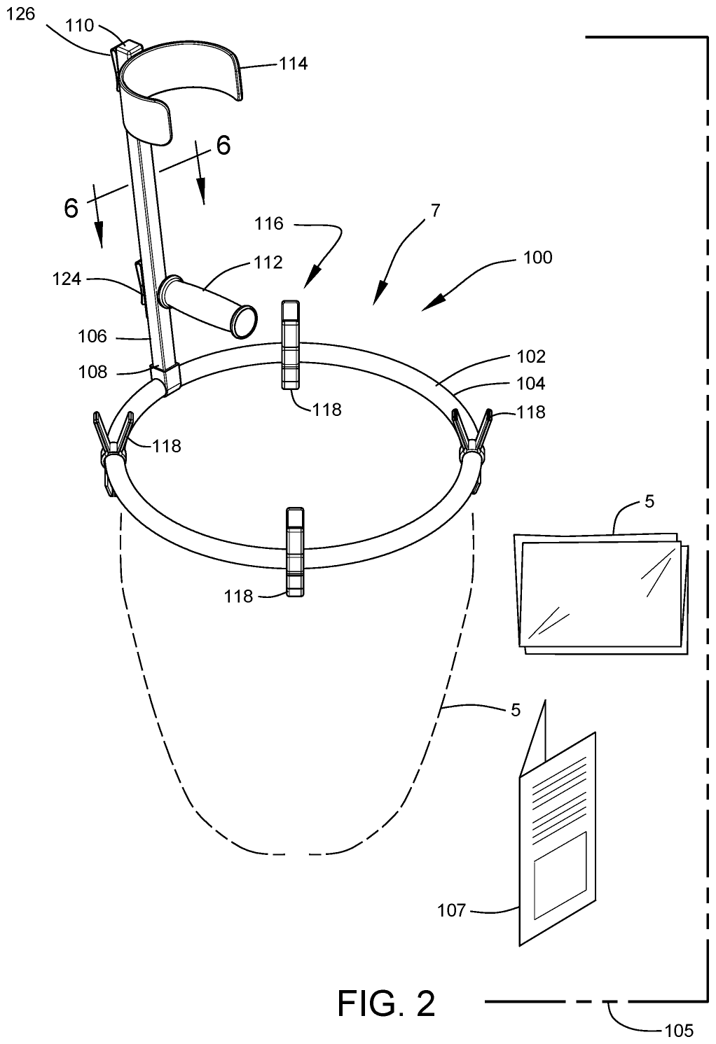

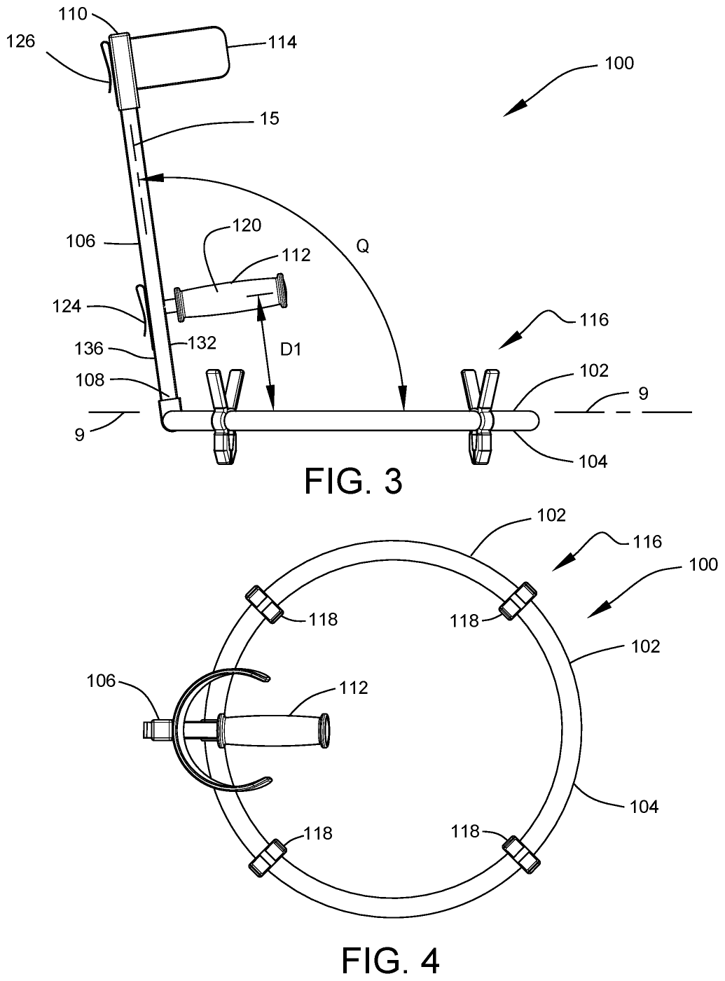

FIG. 2 is a perspective view of the trash handler device 100 of FIG. 1, according to the embodiment of the present disclosure. FIG. 3 is a side view of the trash handler device 100 of FIG. 1, according to an embodiment of the present disclosure. As above, the trash handler device 100 may include the support hoop 102 configured to support the flexible bag 5 in the open position 7, as shown by the dashed-line depiction. The support hoop 102 may include a rigid peripheral member 104 generally disposed within a geometric plane 9 (see FIG. 3) and defining an opening 11 through which articles 13 may pass. The support hoop 102 may have a diameter of about 16 inches.

The elongated arm 106 may be joined with the rigid peripheral member 104 of the support hoop 102, as shown. The elongated arm 106 may have a length of between about 12 and about 14 inches. The elongated arm 106 may include a proximal end 108 located next to the rigid peripheral member 104, a distal end 110 opposite the proximal end 108, and a longitudinal axis 15 extending between the proximal end 108 and such distal end 110. As best illustrated in FIG. 3, the longitudinal axis 15 may be fixed at an angle Q, oblique to the geometric plane 9. More specifically, longitudinal axis 15 and the geometric plane 9 may be fixed an angle Q of between about 1 degree and about 20 degrees. In one arrangement of the present system, the longitudinal axis 15 and the geometric plane 9 may be fixed an angle Q of about 15 degrees. Upon reading this specification, it should be appreciated that, under appropriate circumstances, considering such issues as user preferences, design preference, structural requirements, marketing preferences, cost, available materials, and the like, other angular relationships such as, for example, the longitudinal axis of an elongated arm may be fixed at an angle generally perpendicular to the geometric plane, and the like, may be sufficient.

The handgrip 112 may be joined with the elongated arm 106 at a position between the proximal end 108 and the distal end 110, as shown. The handgrip 112 may be joined with the elongated arm 106 in a generally perpendicular orientation, as shown. The handgrip 112 may extend about 5 inches outwardly from the elongated arm 106 and may point toward the center of the support hoop 102, as illustrated in the top view of FIG. 4. In one version, the handgrip 112 sits on the elongated arm 106 about 4 inches from the support hoop 102.

The handgrip 112 may include a generally tubular member having at least one friction-enhancing material 120 configured to assist manual gripping of the handgrip 112. The friction-enhancing material 120 may comprise foam, rubber, plastic, or other suitable material. Rubber-like materials, such as nitrile rubber, may be suitable for use in forming the outer surface of the grip. But other materials of sufficient strength and durability may also be employed.

The arm cuff 114 may be joined with the elongated arm 106 at or near the distal end 110. FIG. 1 shows the arm cuff 114 supplied as a generally U-shaped member 122 configured to contact the user's arm. The arm cuff 114 may add lateral stability to the trash handler device 100 during use. The arm cuff 114 may be of suitable size and shape comprising metal (steel, aluminum, or other), plastic, composite material, or other suitable material. The U-shaped member 122 may be of a fixed size or may have an adjustment feature to assist in fitting the cuff to the user's arm.

The bag attacher 116 may be used to removably attach the flexible bag 5 to the rigid peripheral member 104 of the support hoop 102, as shown in FIG. 1 and FIG. 2. The bag attacher 116 may comprise a set of spring-actuated clips 118 each one configured to removably attach the flexible bag 5 to the rigid peripheral member 104 of the support hoop 102, as shown in FIG. 1 and FIG. 2. Upon reading this specification, it should be appreciated that, under appropriate circumstances, considering such issues as user preferences, design preference, structural requirements, marketing preferences, cost, available materials, and the like, other attachment arrangements such as, for example, the use of clamps, hooks, releasable adhesives, securing bands, ties, hook-and-loop fasteners, and the like, may be sufficient.

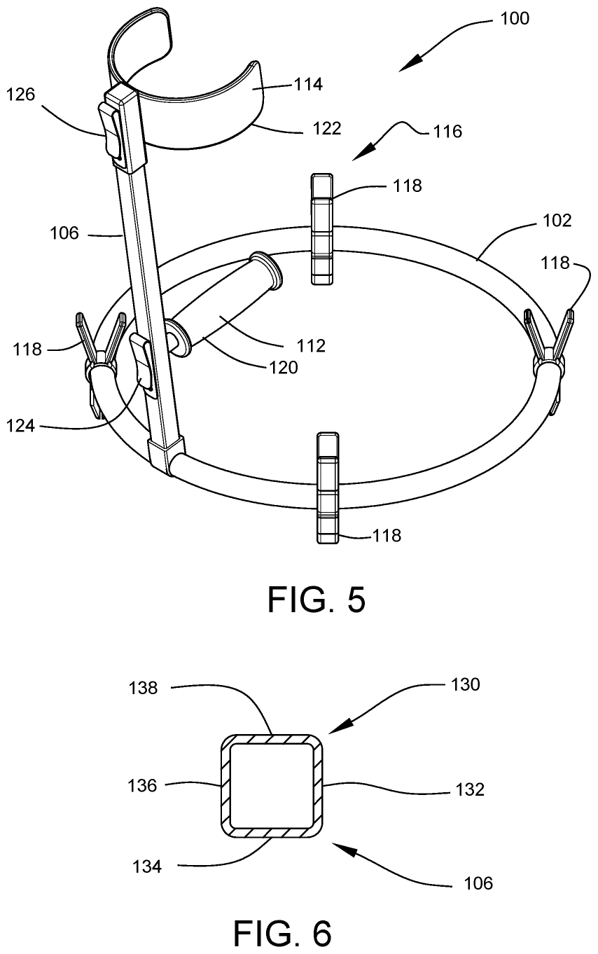

FIG. 5 is a perspective view of the trash handler device 100 of FIG. 1, according to an embodiment of the present disclosure. The trash handler device 100 may further include a first belt clip 124 configured to support the trash handler device 100 from a belt 17 of the user (see also FIG. 1). The first belt clip 124 may be mounted to the elongated arm 106 in a positioned next to handgrip 112, as shown. The trash handler device 100 may additionally include a second belt clip 126 configured to support the trash handler device 100 from the belt 17 of the user. The second belt clip 126 may be mounted to the arm cuff 114.

FIG. 6 is a sectional view through section 6-6 of FIG. 2, an elongated arm of the trash handler device 100 of FIG. 1, according to an embodiment of the present disclosure. The elongated arm 106 of the trash handler device 100 may have a quadrilateral cross-section 130 having a first side 132, a second side 134, a third side 136 opposite the first side 132, and a fourth side 138 opposite the second side 134. Referencing FIG. 1 through FIG. 6, the support hoop 102 may be arranged to extend outwardly from the first side 132 of the elongated arm 106. Further, the handgrip 112 may be arranged to project outwardly from the first side 132 of the elongated arm 106. Even further, the first belt clip 124 is mounted to such third side 136 of such elongated arm 106. Under appropriate circumstances, considering such issues as user preferences, design preference, structural requirements, marketing preferences, cost, available materials, technological advances, and the like, other cross-sectional arrangements such as, for example, circular, oval, multi-sided polygons, and the like, may be useful.

The trash handler device 100 may be constructed from one or more durable and lightweight materials. The support hoop 102 and such elongated arm 106 may be constructed from a rigid metallic material. Under appropriate circumstances, considering such issues as user preferences, design preference, structural requirements, marketing preferences, cost, available materials, and the like, other material arrangements such as, for example, the use of lightweight composites, injection-molded plastics, natural wood or bamboo, and the like, may be useful.

Referencing FIG. 2, the trash handler device 100 may be arranged as a kit 105. In particular, the trash handler device 100 may further include a plurality of the flexible bags 5 and a set of instructions 107. The instructions 107 may detail functional relationships to the structure of the trash handler device 100 such that the trash handler device 100 can be used, maintained, or the like, in a preferred manner.

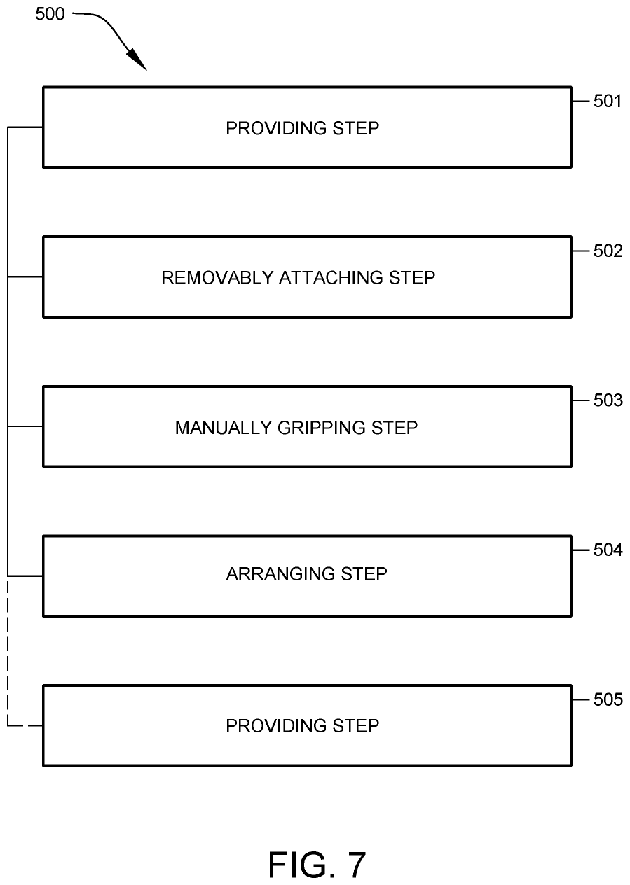

FIG. 7 is a flow diagram illustrating a method of using a trash handler device 100 to hold a flexible bag 5 in an open position 7 to facilitate the depositing of articles therein, the method of use 500 may comprise the steps of: step one, 501, providing a trash handler device 100 comprising a support hoop 102 configured to support the flexible bag 5 in the open position 7, such support hoop 102 having providing a rigid peripheral member 104 generally disposed within a geometric plane 9 and defining an opening 11 through which articles 13 may pass, an elongated arm 106 joined with such support hoop 102, such elongated arm 106 having a proximal end 108 extending outwardly from such rigid peripheral member 104, a distal end 110 opposite the proximal end 108, and a longitudinal axis 15 extending between such proximal end 108 and such distal end 110, such longitudinal axis 15 fixed at an angle Q oblique to such geometric plane 9, a handgrip 112 configured to assist manual gripping of such elongated arm 106, such handgrip 112 joined with such elongated arm 106 at a position between such proximal end 108 and such distal end 110, an arm cuff 114 configured to supportively engage a user's arm during use, such arm cuff 114 joined with such elongated arm 106 at a position next such distal end 110, and a set of spring-actuated clips 118 each one configured to removably attach the flexible bag 5 to the rigid peripheral member 104 of the support hoop 102; step two 502, removably attaching the flexible bag 5 to the support hoop 102 in the open position 7 using the set of spring-actuated clips 118; step three 503, manually gripping the handgrip 112 to assist user positioning of the opening 11; and step four 504, arranging the trash handler device 100 such that the U-shaped member 122 partially encircles a user's arm; whereby the flexible bag 5 is held by the user in an open position 7 to facilitate the depositing of the debris therein.

Even further, the method of use 500 may further comprise five 505, providing the trash handler device 100 with at least one belt clip to assist supporting the trash handler device 100 from a belt of the user.

Step 505 is optional and may not be implemented in all cases. Optional steps of the method of use 500 are illustrated using dotted lines in FIG. 7 to distinguish them from the other steps of the method of use 500. The steps described in the method of use can be carried out in many different orders according to user preference. The use of “step of” does not mean “step for” and is not intended to invoke the provisions of 35 U.S.C. § 112(f). Under appropriate circumstances, considering such issues as design preference, user preferences, marketing preferences, cost, structural requirements, available materials, technological advances, and the like, other methods for implementing a trash handler device may be suitable.

What is claimed is:

1. A trash handler device comprising:
a support hoop having a peripheral member defining an opening within a plane wherein the hoop is configured to hold a bag open;
an elongated arm joined with the hoop, wherein the arm has
a first end located next to the member,
a second end opposite the first end,
and
an axis fixed at an angle that is oblique to the plane extending between the ends;
a handgrip joined at a midpoint of the arm;
an arm cuff joined to the arm adjacent to the second end wherein the cuff is configured to engage a user's arm;
and
a bag attacher on the member.

2. The trash handler device of claim 1, wherein the angle is between about 1-20 degrees.

3. The trash handler device of claim 1, wherein the angle is about 15 degrees.

4. The trash handler device of claim 1, wherein the bag attacher comprises spring-actuated clips configured to attach the bag to the member.

5. The trash handler device of claim 1, wherein the handgrip joins the arm about 4 inches from the hoop.

6. The trash handler device of claim 1, wherein the handgrip joins with the arm perpendicularly.

7. The trash handler device of claim 1, wherein the handgrip comprises at least one friction-enhancing material.

8. The trash handler device of claim 1, wherein the cuff comprises a U-shaped member configured to receive the user's arm.

9. The trash handler device of claim 1, further comprising a first belt clip mounted to the arm.

10. The trash handler device of claim 9, wherein the first belt clip sits next to the handgrip.

11. The trash handler device of claim 1, further comprising a second belt clip mounted to the cuff.

12. The trash handler device of claim 1, wherein the elongated arm has a quadrilateral cross-section having first, second, third, and fourth sides.

13. The trash handler device of claim 12, wherein the support hoop extends out from the first side.

14. The trash handler device of claim 12, wherein the handgrip extends out from the first side.

15. The trash handler device of claim 12, wherein a first belt clip mounts to the third side.

16. The trash handler device of claim 1, wherein the hoop and the arm are constructed from a metallic material.

17. A trash handler device comprising:
a support hoop configured to hold a bag open, wherein the hoop has a peripheral member defining an opening within a plane;
an elongated arm joined with the hoop and having a first end located next to the member, a second end opposite the first end, and an axis extending between the ends, fixed at an oblique angle to the plane;
a handgrip joined to the arm 4 inches from the hoop;
an arm cuff configured to engage a user's arm connected adjacent to the second end;
a bag attacher configured to attach the bag to the member;
a first belt clip mounted to a third side of the arm positioned next to the handgrip and configured to support the device from a user's belt;
and
a second belt clip mounted to the cuff configured to support the device from the belt,
wherein the angle is between 1 degree and 20 degrees;
wherein the bag attacher comprises spring-actuated clips configured to attach the bag to the member;
wherein the handgrip joins with the arm perpendicularly;
wherein the handgrip comprises at least one friction-enhancing material;
wherein the cuff comprises a U-shaped member configured to partially encircle a user's arm;
wherein the arm comprises a quadrilateral cross-section having a first side, a second side, the third side, and a fourth side;
wherein the hoop extends out from the first side;
wherein the handgrip extends out from the first side;
and
wherein the hoop and the arm are constructed from a metallic material.

18. The trash handler device of claim 17, further comprising a plurality of the bags, a set of instructions, and wherein the trash handler device is arranged as a kit.

19. A method of using a trash handler comprising the steps of:
providing the trash handler wherein the trash handler comprises
a support hoop configured to hold a bag open and having a peripheral member defining an opening within a plane,
an elongated arm joined with the hoop, having a first end extending out from the member,
a second end opposite the first end, and an axis extending between the ends at an angle oblique to the plane,
a handgrip joined with the arm between the ends,
a cuff configured to engage a user's, joined with the arm adjacent to the second end,
and
spring-actuated clips configured to removably attach the bag to the member;
holding the bag open by removably attaching the bag to the hoop using the spring-actuated clips;
manually gripping the handgrip;
and
partially encircling a user's arm with a U-shaped member.

20. The method of claim 19, further comprising supporting the trash handler from a user's belt using a belt clip.
